(19) United States
(12) Patent Application Publication
(10) Pub. No.: US 2010/0208548 A1
(43) Pub. Date: Aug. 19, 2010

(54) BOWL FOR MIXING MACHINE

(75) Inventors: David W. Hemelgarn, Dayton, OH (US); Brian R. Kadel, Dayton, OH (US); Thomas S. Donthnier, Vandalia, OH (US)

Correspondence Address: THOMPSON HINE LLP;Intellectual Property Group, P.O Box 8801, DAYTON, OH, 45401-8801, US

(73) Assignee: Premark FEG L.L.C., Wilmington, DE (US)

(21) Appl. No.: 12/372,256

(22) Filed: Feb. 17, 2009

(51) Int. Cl. B01F 7/00

(52) U.S. Cl. 366/198

(57) ABSTRACT

A mixing machine mixer bowl includes a handle with laterally extending thumb rests to facilitate user handling of the mixer bowl.

### TECHNICAL FIELD

This application relates generally to mixing machines and, more particularly to a bowl for use with a mixing machine.

### BACKGROUND

Mixers are used to mix and blend a variety of materials, such as food product. Typically, the materials are placed in a bowl and the bowl is located below a mixer head that includes a rotatable output member with a mixer tool. Various arrangements have been used to support the bowl beneath the mixer head, and various bowl configurations have been provided. It would be desirable to provide a mixer bowl with one or more features that facilitate user handling of the mixer bowl.

### SUMMARY

In one aspect, a mixer bowl includes a bowl body defining an interior space for receiving food product. A first mount bracket is located on an exterior surface of the bowl body. A second mount bracket is located on the exterior surface of the bowl body and is circumferentially spaced from the first mount bracket. A handle is located on the exterior surface of the bowl body. The handle is disposed between the first mount bracket and the second mount bracket and includes an upper portion defining laterally extending thumb rests for receiving a users thumb.

In another aspect, a mixer bowl includes a bowl body defining an interior space for receiving food product and at least one mount bracket located on an exterior surface of the bowl body and having a mount opening therein. A handle is located on the exterior surface of the bowl body and is circumferentially offset from the mount bracket. The handle includes a primarily upright grip part and an upper portion defining laterally extending thumb rests. The laterally extending thumb rests define a width that is at least 50% greater than a largest width of the grip part.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of a mixing machine and mixer bowl;

FIG. 2 is a perspective view of the mixer bowl;

FIG. 3 is side view of the mixer bowl; and

FIG. 4 is a partial cross-section of the mixer bowl.

### DETAILED DESCRIPTION

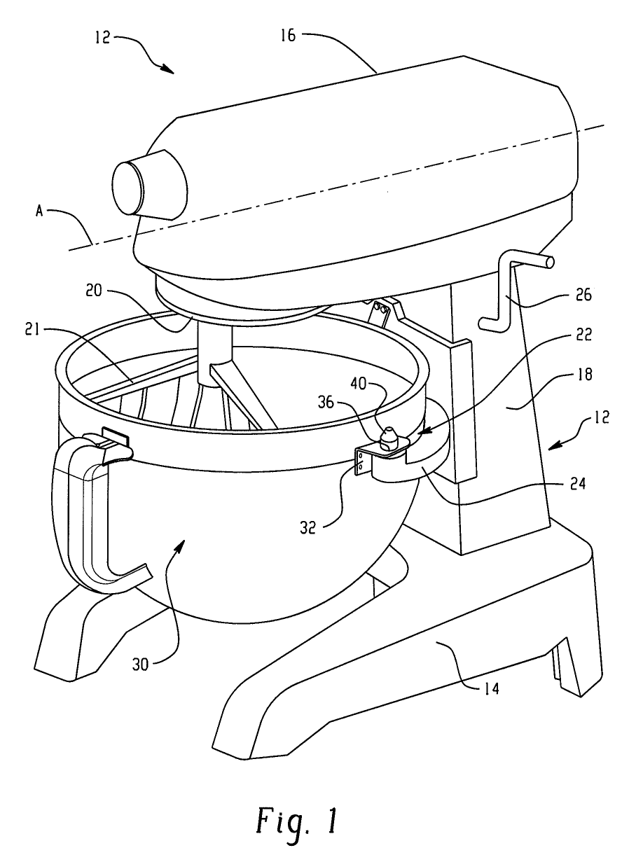

Referring to FIG. 1, a mixing machine 10 includes a mixer body 12 having a base portion 14, a head portion 16 and a support portion 18 (e.g., in the form of a column) connecting the head portion and the base portion in a vertically spaced-apart relationship. A front-to-back head portion axis A is shown. An output member 20 (e.g., a shaft for receiving a mixer tool 21) extends downward from the head portion 16 in a direction toward a bowl receiving location 22 formed between arms 24 of a bowl receiving assembly that can be moved up and down relative to the head portion 16 via a handle 26. A motor is located within the head portion 16 and may be mechanically linked to the output member 20, as by a gear system or belt arrangement, for effecting rotation of the output member about a first axis and rotation of the first axis about a second axis (e.g., a planetary movement or rotation).

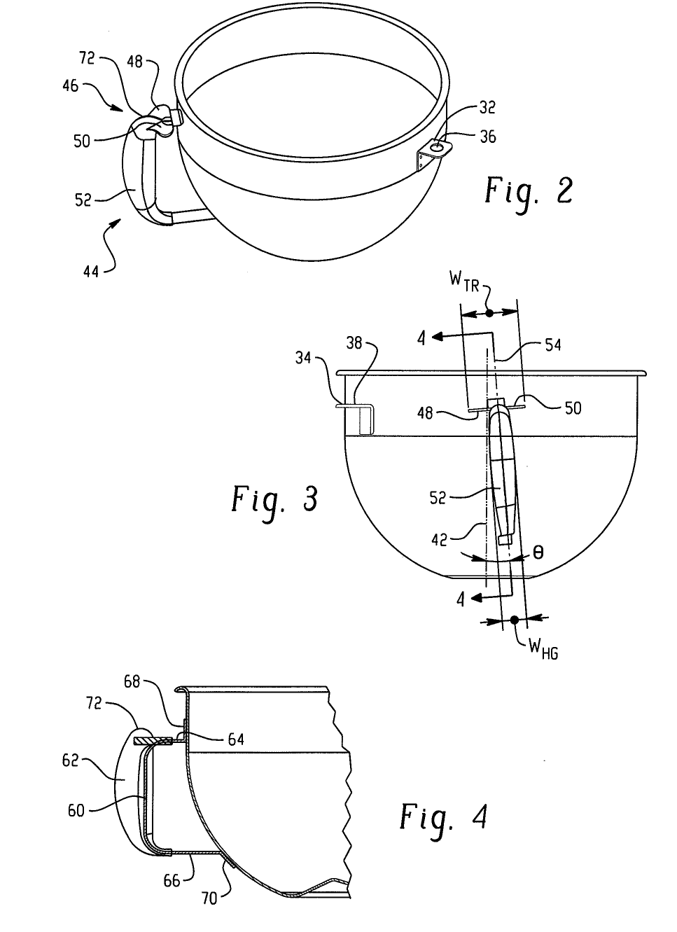

Referring to FIGS. 1-4, a bowl 30 is positioned on the bowl receiving assembly using circumferentially spaced apart mount brackets 32, 34 that are located on the exterior surface of the bowl body 36. Each mount bracket includes an opening 36, 38 for receiving a pin 40 located on one of the respective arms 24 of the mixer. The bowl has a central bowl axis 42 extending from the bottom of the bowl upward through the top opening of the bowl. A handle 44 is located on the exterior surface of the bowl body between the mount brackets 32, 34. In one implementation, the circumferential spacing between bracket 34 and the handle is between about 50 to 70 degrees (more preferably between about 55 and 65 degrees) and the circumferential spacing between the bracket 32 and the handle is between about 90 to 110 degrees (more preferably between about 95 to 105 degrees), where such spacing is measured from the center axis of the opening in each bracket to the center axis of the handle at the top of the handle.

The handle includes a top portion 46 defining laterally extending thumb rests 48 and 50 for receiving a users thumb during handling of the bowl. The thumb rests provide the user with an ergonomic configuration for stabilizing the bowl during use (e.g., if a use is holding the bowl and manually mixing food product within the bowl). In the illustrated embodiment, each thumb rest 48 and 50 is spaced apart from the exterior surface of the bowl.

The handle includes a primarily upright grip portion 52 and the laterally extending thumb rests 48 and 50 are located proximate to the top of the grip portion. The grip portion has a lengthwise axis 54 that, in side elevation (e.g., per FIG. 3), is offset from the central bowl axis 42 by an angle θ of between about 3 degrees and ten degrees, more preferably between about 4 degrees and six degrees. The angled nature of the handle facilitates user handling of the bowl (e.g., when a user is holding the bowl by the handle with his/her left hand the bowl will naturally tend to tilt toward the user do to the handle angle, which is a desirable orientation for manual mixing of food product within the bowl). As used herein, the terminology “primarily upright” means having a lengthwise axis that, in side elevation, is offset from vertical by no more than 25 degrees.

The illustrated handle includes a metal bracket portion 60 and a overmolded, plastic portion 62 along the bracket portion. The metal bracket portion includes an extending and exposed upper part 64 that is welded, or otherwsie fastened, to the exterior surface of the bowl body and an extending an exposed lower part 66 that is welded, or otherwise fastened, to the exterior surface of the bowl body. The upper part 64 includes an upward bend 68 having one side that rests against the exterior surface of the bowl body and the lower part 66 includes a downwardly angled bend 70 that has one side that rests against the bowl body. The overmolded portion 62 defines both the primarily upright grip portion or part 52 and the laterally extending thumb rests 48 and 50. In one implementation the laterally extending thumb rests define a width WTR that is at least 30% greater than a largest width WHG of the handle grip part, or more preferably at least 50% greater than the largest width of the handle grip part, or more preferably at least 75% greater than the largest width of handle grip part. By way of example, WTR may be between about 1.90 and 2.10 inches, and WHG may be between about 0.95 and 1.15 inches. Such width facilitates a user's use of his/her thumb for lateral stability of the bowl when holding the bowl by the handle.

In use, the thumb rests define areas for receiving an end portion of a user's thumb and are located near the top of the handle grip part. The top of the handle grip part includes a thumb base support part 72 positioned above and angling downward toward the thumb rests 48 and 50, again providing for increased stability during user handling of the bowl via the handle.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application.

What is claimed is:

1. A mixer bowl, comprising:
a bowl body defining an interior space for receiving food product;
a first mount bracket located on an exterior surface of the bowl body;
a second mount bracket located on the exterior surface of the bowl body and circumferentially spaced from the first mount bracket; and
a handle located on the exterior surface of the bowl body, the handle disposed between the first mount bracket and the second mount bracket, the handle including an upper portion defining laterally extending thumb rests for receiving a users thumb.

2. The mixer bowl of claim 1 wherein the handle includes a primarily upright grip portion, the laterally extending thumb rests located proximate to the top of the grip portion.

3. The mixer bowl of claim 2 wherein the mixer bowl has a central bowl axis extending from the bottom of the bowl upward through the top opening of the bowl, the grip portion has an axis that, in side elevation, is offset from the central bowl axis by an angle of between about 3 degrees and ten degrees.

4. The mixer bowl of claim 3 wherein the axis of the grip portion is offset from the central bowl axis by an angle of about four to six degrees.

5. The mixer bowl of claim 1 wherein the handle comprises a metal bracket portion and a overmolded portion along the bracket portion, the bracket portion including an exposed upper part that is welded to the exterior surface of the bowl body and an exposed lower part that is welded to the exterior surface of the bowl body, the overmolded portion defines both a primarily upstanding handle grip part and the laterally extending thumb rests proximate the top of the handle grip part.

6. The mixer bowl of claim 5 wherein the laterally extending thumb rests define a width that is at least 30% greater than a largest width of the handle grip part.

7. The mixer bowl of claim 6 wherein the width defined by the laterally extending thumb rests is at least 50% greater than the largest width of the handle grip part.

8. The mixer bowl of claim 1 wherein the thumb rests comprise areas for receiving an end portion of a user's thumb, the handle includes a primarily upright grip part, the thumb rests are located near the top of the handle grip part, and the top of the handle grip part includes a thumb base support part positioned above and angling downward toward the thumb rests.

9. The mixer bowl of claim 1 wherein the thumb rest areas are spaced apart from the exterior surface of the bowl body.

10. The mixer bowl of claim 1 wherein a circumferential spacing between a center axis of an opening in the first bracket and a center axis of the handle at the top of the handle is between about 50 to 70 degrees and a circumferential spacing between a center axis of an opening in the second bracket and the center axis of the handle at the top of the handle is between about 90 to 110 degrees.

11. A mixer bowl, comprising:
a bowl body defining an interior space for receiving food product;
at least one mount bracket located on an exterior surface of the bowl body and having a mount opening therein;
a handle located on the exterior surface of the bowl body, the handle circumferentially offset from the mount bracket and including a primarily upright grip part and an upper portion defining laterally extending thumb rests, the laterally extending thumb rests define a width that is at least 50% greater than a largest width of the grip part.

12. The mixer bowl of claim 11 wherein the handle comprises a metal bracket portion and an overmolded portion along the bracket portion, the bracket portion including an exposed upper part that is welded to the exterior surface of the bowl body and an exposed lower part that is welded to the exterior surface of the bowl body, the overmolded portion defines both the grip part and the laterally extending thumb rests.

13. The mixer bowl of claim 12 wherein the thumb rests comprise areas for receiving an end portion of a user's thumb, the handle grip part includes a thumb base support part that angles downward toward the laterally extending thumb rests.
